(19) United States
(12) Patent Application Publication
(10) Pub. No.: US 2018/0141404 A1
(43) Pub. Date: May 24, 2018

(54) Rear Seat Air Regulating Device for HVAC Module

(71) Applicant: Hyundai Motor Company, Seoul (KR)

(72) Inventor: Dong Won Yeon, Hwaseong-si (KR)

(21) Appl. No.: 15/499,549

(22) Filed: Apr. 27, 2017

(30) Foreign Application Priority Data
Nov. 22, 2016 (KR) 10-2016-0155416

(51) Int. Cl. B60H 1/00; B60H 1/24; B60H 1/34

(52) U.S. Cl. CPC B60H 1/00057; B60H 1/00564; B60H 2001/3485; B60H 1/3414; B60H 2001/00242; B60H 1/244

(57) ABSTRACT

A rear seat air regulating device includes a housing that has an air inlet formed at one side thereof, a front seat air passage, and a front seat air outlet formed at an upper portion thereof. The housing also has a rear seat air passage and a rear seat air outlet formed at a lower portion thereof. An evaporator and a heater are inside of the housing. A rear seat temperature door is mounted at the inlet of the heater in a manner of being rotated angularly to block or allow the air flowing to the heater. A rear seat mixing door is mounted where an outlet of the heater joins the rear seat air passage in a manner of being rotated angularly so that the mixing door performs opening and closing of the outlet of the heater and opening and closing of the rear seat air passage simultaneously.

### CROSS-REFERENCE TO RELATED APPLICATIONS

This application claims under 35 U.S.C. § 119(a) the benefit of priority to Korean Patent Application No. 10-2016-0155416 filed on Nov. 22, 2016, the entire contents of which are incorporated herein by reference.

### TECHNICAL FIELD

The present disclosure relates to a heating, ventilating and air conditioning (HVAC) module for an automotive vehicle.

### BACKGROUND

In general, a vehicle is equipped with an HVAC module as an air conditioner for cooling and heating.

The HVAC module includes a housing having an air inlet and an air outlet, an evaporator mounted on the air inlet side of the housing to cool the air and a heater mounted in the housing to heat the air. In addition, a plurality of wind direction controls are mounted in the housing doors for guiding air discharge direction.

Accordingly, upon cooling operation of the vehicle, the air flowing into the air inlet of the housing is cooled by passing through the evaporator and then discharged to the inside through a vent along the guide direction of the wind direction control door. On the other hand, upon heating operation of the vehicle, the air flowing into the air inlet of the housing is heated by means of the heater and then discharged to the inside through the vent along the guide direction of the wind direction control door.

Such a HVAC module is manufactured in a structure having a control module for front seats that is configured to discharge the air to a plurality of vents for front seats (i.e., a center vent, side vents, defrosters, etc.), or a structure in which a control module for front seats and a control module for rear seats that is configured to discharge the air to vents for rear seats (i.e., a rear floor vent, a console vent, etc.) are integrally formed.

Hereinafter, configuration and operation of a conventional control module for rear seats of an HVAC module will be described.

FIG. 1 is a cross-sectional view illustrating a conventional control module for rear seats in a closed state and FIG. 2 is a cross-sectional view illustrating an air mixing mode of the conventional control module for rear seats.

In FIGS. 1 and 2, reference numeral 10 denotes a housing.

An air inlet 12 is formed at one side of the housing 10, an air passage for front seats 13 (i.e., a front seat air passage 13) and an air outlet for front seats 14 (i.e., a front seat air outlet) are formed at an upper portion of the housing, while an air passage for rear seats 15 and an air outlet for rear seats 16 are formed at a lower portion of the housing.

In this case, the front seat air outlet 14 is divided into a center outlet 14-1 for discharging the air toward both a driver seat and a passenger seat and a defroster outlet 14-2 for discharging the air toward a windshield glass, while the air outlet for rear seats 16 is also divided into a console outlet 16-1 for discharging the air toward a space around the rear seats in the inside and a rear floor outlet 16-2 for discharging the air toward a rear floor.

An evaporator 20 for cooling the air for cooling is disposed inside the air inlet 12 of the housing 10 and a heater 22 for heating the air for heating is disposed at the rear side of the evaporator 20.

Further, a first temperature door for rear seats 31 is mounted at an inlet side of the heater 22 in a manner of being rotated angularly by an actuator (not shown). This first temperature door for rear seats 31 serves to open and close the inlet of the heater 22, or open and close the air passage for rear seats 15.

Further, a second temperature door for rear seats 32 is mounted at an outlet side of the heater 22 in a manner of being rotated angularly by an actuator (not shown). This second temperature door for rear seats 32 serves to open and close the outlet of the heater 22.

In addition, an opening/closing door for rear seats 33 for allowing or blocking the airflow to the rear seats is mounted at the air passage for rear seats 15 in a manner of being rotated angularly by an actuator (not shown).

Further, a mode door for rear seats 34 (i.e., a rear seat mode door 34) for discharging the air selectively to the console outlet 16-1 or the rear floor outlet 16-2 is mounted at a side of the air outlet for rear seats 16 in a manner of being rotated angularly by an actuator (not shown).

In this case, as can be seen in FIG. 3, the first temperature door for rear seats 31 and the second temperature door for rear seats 32 are connected by a single link 35 to cooperate with each other.

Accordingly, when the first temperature door for rear seats 31 is in a position blocking the inlet of the heater 22 and the opening/closing door for rear seats 33 is in an open state, a Max Cool mode in which cold air that passes through the evaporator 20 is discharged to the air outlet for rear seats 16 via the air passage for rear seats 15 is implemented.

On the other hand, when the first temperature door for rear seats 31 is in a position blocking the air passage for rear seats 15 and the opening/closing door for rear seats 33 is in a closed state and the second temperature door for rear seats 32 is in an open state, a Max Hot mode in which warm air that passes through the heater 22 is discharged to the air outlet for rear seats 16 is implemented.

Further, when the first temperature door for rear seats 31 is controlled to be opened half so that both the inlet of the heater 22 and the air passage for rear seats 15 are opened and the opening/closing door for rear seats 33 is in an open state and the second temperature door for rear seats 32 is also controlled to be opened half, a Mixing mode in which cold air passing through the evaporator 20 and warm air passing through the heater 22 are mixed with each other and discharged to the air outlet for rear seats 16 is implemented.

As can be seen from the above description, the degree of opening/closing of the first and second temperature doors for rear seats 31, 32 is adjusted in order to control temperature in the area of the rear seats and the first and second temperature doors are linked with each other by a link. Therefore, there are drawbacks in that the degree of opening/closing cannot be adjusted precisely and thereby it is difficult to tune finely regulation of temperature of the air at the time of the Mixing mode.

Further, there are problems that since four or more doors such as first and second temperature doors for rear seats, an opening/closing door for rear seats and a mode door for rear seats are mounted in order to implement the Max Cool mode, the Max Hot mode, the Mixing mode and the like as described above and furthermore the first and second temperature doors for rear seats are connected with each other by a link, structure of the entire HVAC module becomes complicated and as a result the number of parts and manufacturing cost are increased.

The above information disclosed in this Background section is only for enhancement of understanding of the background of the invention and therefore it may contain information that does not form the prior art that is already known in this country to a person of ordinary skill in the art.

### SUMMARY

Embodiments of the present invention can solve the above-described problems associated with the prior art. For example, embodiments provide a rear seat air regulating device of a heating, ventilating and air conditioning (HVAC) module, which is adapted to limit the number of air regulating doors to be mounted in the HVAC module for air conditioning of a vehicle to a minimum to smoothly adjust a discharge direction and temperature of the air directed toward rear seats of the vehicle and simplify the internal structure of the HVAC module compared to that in the prior art.

In one aspect, the present disclosure provides a rear seat air regulating device of a heating, ventilating and air conditioning (HVAC) module. A housing has an air inlet formed at one side thereof, an front seat air passage, and a front seat air outlet formed at an upper portion thereof. The housing also has a rear seat air passage and a rear seat air outlet formed at a lower portion thereof. An evaporator is disposed at a position inside the air inlet in the inside of the housing. A heater is disposed to be spaced apart from a rear side of the evaporator in the inside of the housing. A rear seat temperature door is mounted at the inlet of the heater in a manner of being rotated angularly to block or allow the air flowing to the heater. A rear seat mixing door is mounted at a position where an outlet of the heater joins the rear seat air passage in a manner of being rotated angularly so that the mixing door performs opening and closing of the outlet of the heater and opening and closing of the rear seat air passage simultaneously. A rear seat mode door is mounted at the rear seat air outlet in a manner of being rotated angularly to guide the air to a console outlet or a rear floor.

Preferably, a partition wall is formed between an installation space for the heater and an installation space for the rear seat mode door such that the outlet of the heater faces the rear seat air passage.

Further, the rear seat temperature door is made in a structure in which a first wing and a second wing are integrally formed on both sides of a first coupling sleeve for a rotary shaft while they maintain an angle of 180° with respect to each other.

In particular, the rear seat mixing door is made in a structure in which a first door for opening and closing the outlet of the heater and a second door for opening and closing the rear seat air passage are formed integrally with each other while they maintain an angle between 90° or more and less than 180° with respect to each other and in which second coupling sleeves for a rotary shaft are integrally formed on one surface of a boundary portion between the first door and the second door.

Preferably, a reinforcing rib for integrally connecting the first door and the second door is further formed on the other surface of the first door and the second door.

Further, the rear seat mode door comprises symmetrical fan-shaped side plates integrally formed with third coupling sleeves for a rotary shaft and an arcuate opening/closing plate formed integrally between the symmetrical fan-shaped side plates.

Therefore, when the rear seat temperature door is controlled to be opened and the rear seat mixing door is controlled to be in a position where the outlet of the heater is opened and at the same time the rear seat air passage is closed, a Max Hot mode in which warm air passing through the heater is discharged to the rear seat outlet is implemented.

Further, when the rear seat temperature door is controlled to be closed and the rear seat mixing door is controlled to be in a position where the outlet of the heater is closed and at the same time the rear seat air passage is opened, a Max Cool mode in which cold air passing through the evaporator is discharged to the rear seat outlet via the rear seat air passage is implemented.

Further, when the rear seat temperature door is controlled to be opened and the rear seat mixing door is controlled to be in a position where the outlet of the heater is opened half and at the same time the rear seat air passage is opened half, a Mixing mode in which warm air passing through the heater and cold air passing through the evaporator are mixed with each other and then discharged to the rear seat outlet is implemented.

With the above-mentioned means for solving the problems of the prior art, the present invention provides the following effects.

First, a minimum number (i.e., three or less) of doors for regulating the air can be mounted in the HVAC module for air conditioning of a vehicle to smoothly adjust a discharge direction and temperature of the air directed toward rear seats of the vehicle. In addition, since the number of doors is reduced compared to that in the prior art, it is possible to simplify the internal structure of the HVAC module.

Second, since the number of doors is reduced and the internal structure of the HVAC module is simplified compared to those in the prior art, the manufacturing cost of the HVAC module can be reduced.

Third, it is possible to control temperature of the air discharged toward rear seats by means of only one rear seat mixing door installed at a position where the outlet of the heater joins the rear seat air passage.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1 and 2 are cross-sectional views illustrating a closed state and a state of an air mixing mode of a control module for rear seats in the prior art respectively;

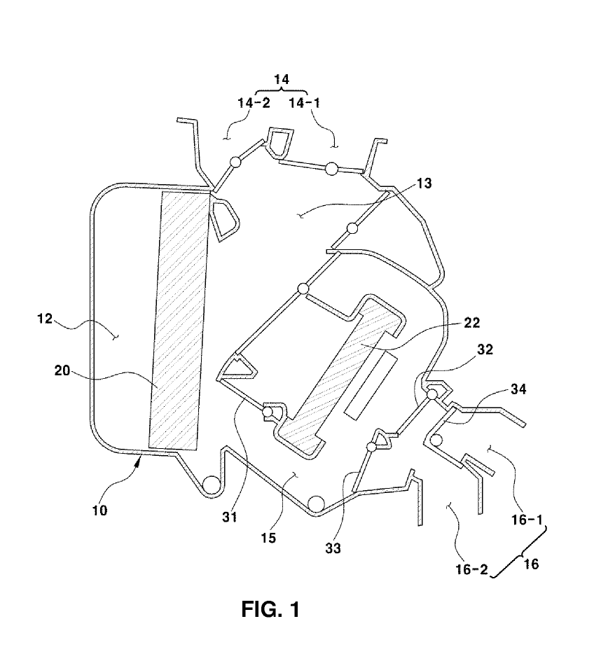

FIG. 3 is a schematic diagram illustrating that a link connecting a first temperature door for rear seats and a second temperature door for rear seats is installed outside a housing enclosing the control module for rear seat in the prior art;

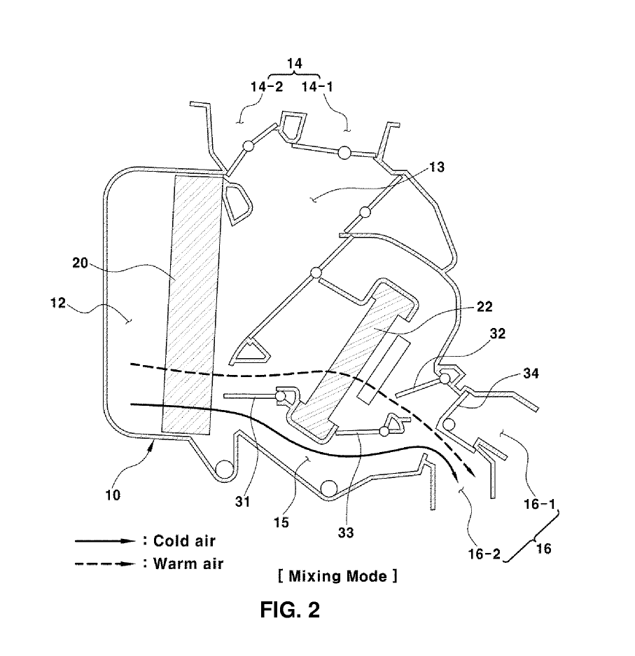

FIG. 4 is a cross-sectional view illustrating a rear seat air regulating device of an HVAC module according to the present invention when the device is in a Max Hot mode;

FIG. 5 is a cross-sectional view illustrating a rear seat air regulating device of an HVAC module according to the present invention when the device is in a Max Cool mode;

FIG. 6 is a cross-sectional view illustrating a rear seat air regulating device of an HVAC module according to the present invention when the device is in a Mixing mode;

FIG. 7 is a perspective view illustrating a temperature door for rear seats out of components of a rear seat air regulating device of an HVAC module according to the present invention;

FIG. 8 is a perspective view illustrating a mixing door for rear seats out of components of a rear seat air regulating device of an HVAC module according to the present invention; and

FIG. 9 is a perspective view illustrating a mode door for rear seats out of components of a rear seat air regulating device of an HVAC module according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF ILLUSTRATIVE EMBODIMENTS

The present disclosure relates to a heating, ventilating and air conditioning (HVAC) module for an automotive vehicle and, in particular examples, to a rear seat air regulating device of the HVAC module, which is adapted to limit the number of air regulating doors to be mounted in the HVAC module to a minimum to smoothly adjust a discharge direction and temperature of the air directed toward the rear seats of the vehicle. Preferred embodiments of the present invention will be described below in more detail with reference to the accompanying drawings.

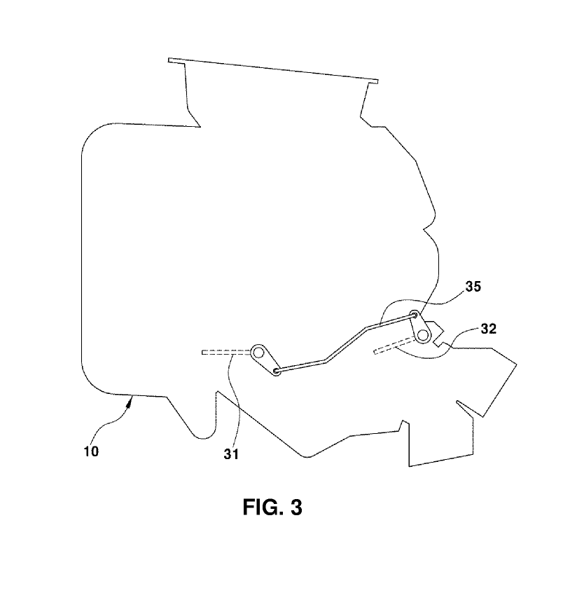

FIGS. 4 to 6 are cross-sectional views illustrating a rear seat air regulating device (i.e., an air regulating device for rear seats of a vehicle) of an HVAC module according to the present invention respectively, wherein reference numeral 10 in each of the figures denotes a housing.

An air inlet 12 is formed at one side of the housing 10, a front seat air passage (i.e., an air passage for front seats 13) and a front seat air outlet 14 (i.e., an air outlet for front seats 14) are formed at an upper portion of the housing, while a rear seat air passage 15 (i.e., an air passage for rear seats 15) and rear seat air outlet 16 (i.e., an air outlet for rear seats 16) are formed at a lower portion of the housing.

In this case, the front seat air outlet 14 is divided into a center outlet 14-1 for discharging the air toward a driver seat and a passenger seat and a defroster outlet 14-2 for discharging the air toward a windshield glass, while the rear seat air outlet 16 is also divided into a console outlet 16-1 for discharging the air toward a space around the rear seats in the inside and a rear floor outlet 16-2 for discharging the air toward a rear floor.

An evaporator 20 for cooling the air for cooling is disposed inside the air inlet 12 of the housing 10 and a heater 22 for heating the air for heating is disposed at the rear side of the evaporator 20.

In this case, a rear seat temperature door 100 (i.e., a temperature door for rear seats 100) for allowing or blocking the air flowing from the air inlet 12 to the heater 22 is mounted at an inlet 22-1 of the heater 22 in a manner of being rotated angularly.

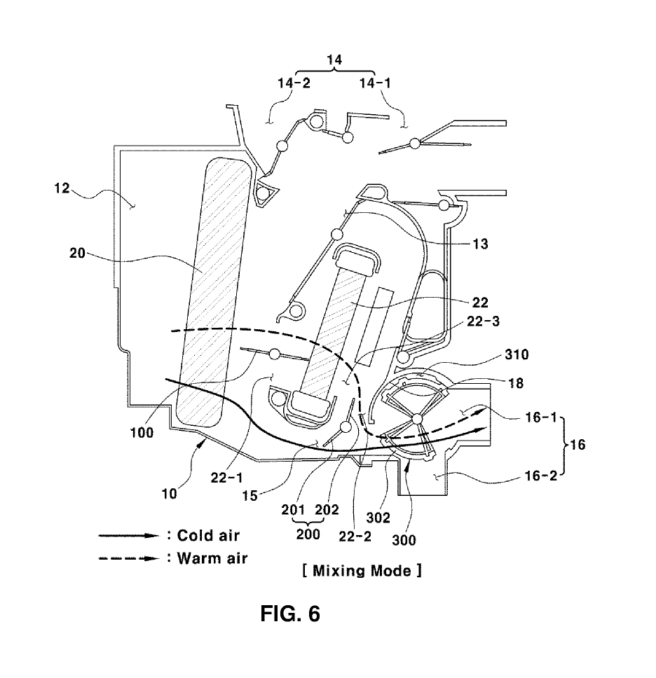

As can be seen in FIG. 7, the rear seat temperature door 100 is made in a structure in which a first wing 101 and a second wing 102 are integrally formed on both sides of a first coupling sleeve for a rotary shaft 103 while they maintain an angle of 180° with respect to each other.

In this case, the first coupling sleeve for a rotary shaft 103 is formed with a spline 104 to which a rotary shaft of an actuator (not shown) is coupled.

On the other hand, a vertical partition wall 18 is formed between an installation space 22-3 of the heater 22 and an installation space 310 of a rear seat mode door 300 (i.e., a mode door for rear seats 300) in such a manner that the outlet 22-2 of the heater 22 faces the rear seat air passage formed at the lower portion of the housing 10.

The reason why the partition wall 18 is formed such that the outlet 22-2 of the heater 22 faces the rear seat air passage 15 is to allow trajectory of angular rotation of a rear seat mixing door 200 (i.e., a mixing door for rear seats 200) to cover both a range of opening and closing of the outlet 22-2 of the heater 22 and a range of opening and closing of the rear seat air passage 15.

Accordingly, the rear seat mixing door 200 is mounted at a position where the outlet 22-2 of the heater 22 joins the rear seat air passage 15 so that opening and closing of the outlet 22-2 of the heater 22 and opening and closing of the rear seat air passage 15 are performed simultaneously.

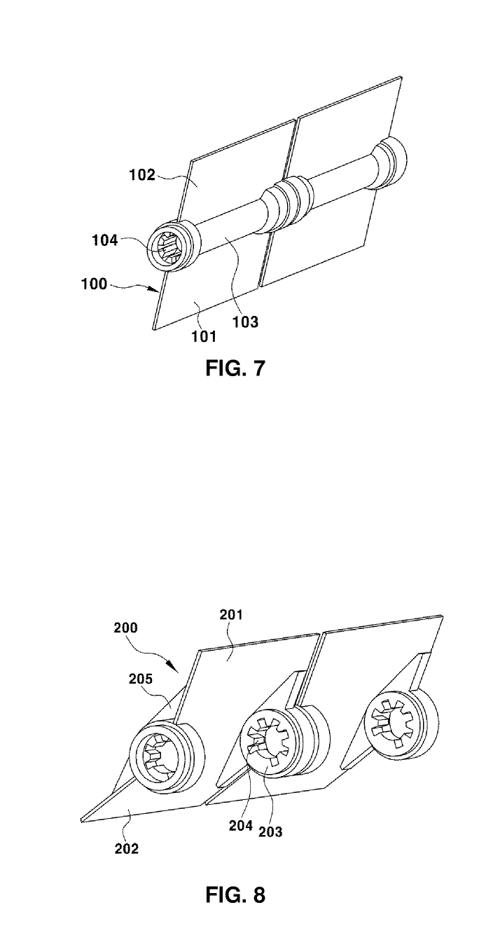

As can be seen in FIG. 8, the rear seat mixing door 200 is made in a structure in which a first door 201 for opening and closing the outlet 22-2 of the heater 22 and a second door 202 for opening and closing the rear seat air passage 15 are formed integrally with each other while they maintain an angle between 90° or more and less than 180° with respect to each other.

The reason why the angle between the first door 201 and the second door 202 is set to an angle within a range between 90° and 180° is to allow the angle between the first door 201 and the second door 202 to match with the angle range between the outlet 22-2 of the heater 22 and the rear seat air passage 15, thereby facilitating to ensure that trajectory of angular rotation of the rear seat mixing door 200 including the first door 201 and the second door 202 covers both a range of opening and closing of the outlet 22-2 of the heater 22 and a range of opening and closing of the rear seat air passage 15.

In this case, second coupling sleeves for a rotary shaft 203 are integrally formed on one surface (e.g., a surface facing the outlets for rear seats) at a boundary portion between the first door 201 and the second door 202 as a rotation center of the rear seat mixing door 200 wherein a spline 204 for connecting with a rotary shaft of an actuator (not shown) is also formed inside each of the second coupling sleeves for a rotary shaft 203.

Further, a reinforcing rib 205 for integrally connecting the first door 201 and the second door 202 is further formed on the other surface of the first door 201 and the second door 202 so that rigidity and durability of the rear seat mixing door 200 can be ensured.

In this case, a rear seat mode door 300 (i.e., a mode door for rear seats 300) for discharging the air selectively to the console outlet 16-1 or the rear floor outlet 16-2 is mounted at a side of the rear seat air outlet 16 in a manner of being rotated angularly.

That is, the rear seat mode door 300 for discharging the air selectively to the console outlet 16-1 or the rear floor outlet 16-2 is mounted in the installation space 310 for the rear seat mode door 300, wherein the partition wall 18 is interposed between said installation space and the installation space 22-3 for the heater 22.

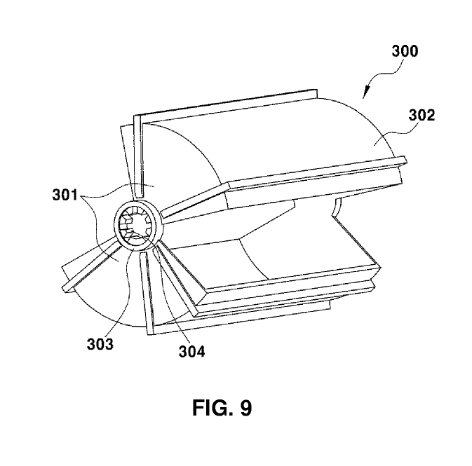

As can be seen in FIG. 9, the rear seat mode door 300 comprises symmetrical fan-shaped side plates 301 integrally formed with third shaft sleeves for a rotary shaft 303 and an arcuate opening/closing plate 302 formed integrally between the symmetrical fan-shaped side plates 301.

More specifically, the symmetrical fan-shaped side plates 301 refer to a configuration in which a pair of fan-shaped side plates 301 are symmetrically arranged between the third coupling sleeves for a rotary shaft 303, while the arcuate opening/closing plate 302 is made of a structure of a plate body which draws the same arch as an arc section of the side plate 301 and it is integrally connected between front ends of the symmetrical fan-shaped side plates 301.

In this case, each of the third coupling sleeves for a rotary shaft 303 is formed with a spline 304 to which a rotary shaft of an actuator (not shown) is coupled.

Therefore, as the rear seat mode door 300 rotates, the console outlet 16-1 (i.e., outlet facing space around rear seats) or the rear floor outlet 16-2 (i.e., outlet facing a floor around rear seats) is opened, or both the console outlet 16-1 and the rear floor outlet 16-2 are opened, so that a direction of discharging the air to the rear seats can be selectively changed.

Operational flow of the rear seat air regulating device of the HVAC module according to embodiments of the present invention is now described below.

### Max Hot Mode

In the Max Hot mode for heating the interior of the vehicle, warm air passing through the heater can be discharged to the area of rear seats.

To this end, as can be seen in FIG. 4, the rear seat temperature door 100 is opened while the rear seat mixing door 200 is controlled to be rotated angularly to a position where the outlet 22-2 of the heater 22 is opened and at the same time the rear seat air passage 15 is closed.

Therefore, the air introduced through the air inlet 12 passes through the rear seat temperature door 100 and is heated by the heater 22, and then it passes through the outlet 22-2 and is discharged toward the rear seat air outlet 16.

In this case, the rear seat mode door 300 is rotated angularly in response to user's selection operation and hence the console outlet 16-1 or the rear floor outlet 16-2 is opened or both the console outlet 16-1 and the rear floor outlet 16-2 are opened, so that the warm air is discharged toward the desired area of rear seats.

### Max Cool Mode

In the Max Cool mode for cooling the interior of the vehicle, cold air passing through the evaporator can be discharged to the area of rear seats.

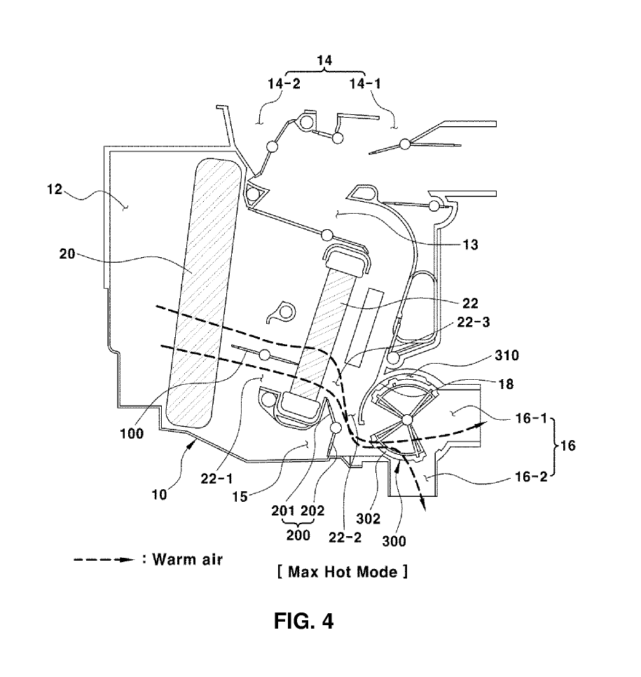

To this end, as can be seen in FIG. 5, the rear seat temperature door 100 is closed while the rear seat mixing door 200 is controlled to be rotated angularly to a position where the outlet 22-2 of the heater 22 is closed and at the same time the rear seat air passage 15 is opened.

Therefore, the air introduced through the air inlet 12 is cooled in the evaporator 20 and then discharged toward the rear seat air outlet 16 via the rear seat air passage 15.

Similarly, the rear seat mode door 300 is rotated angularly in response to user's selection operation and hence the console outlet 16-1 or the rear floor outlet 16-2 is opened or both the console outlet 16-1 and the rear floor outlet 16-2 are opened, so that the cold air is discharged toward the desired area of rear seats.

### Mixing Mode

The mixing mode refers to a mode for discharging the air at a desired temperature resulting from mixing cold air and warm air with each other toward the area of rear seats.

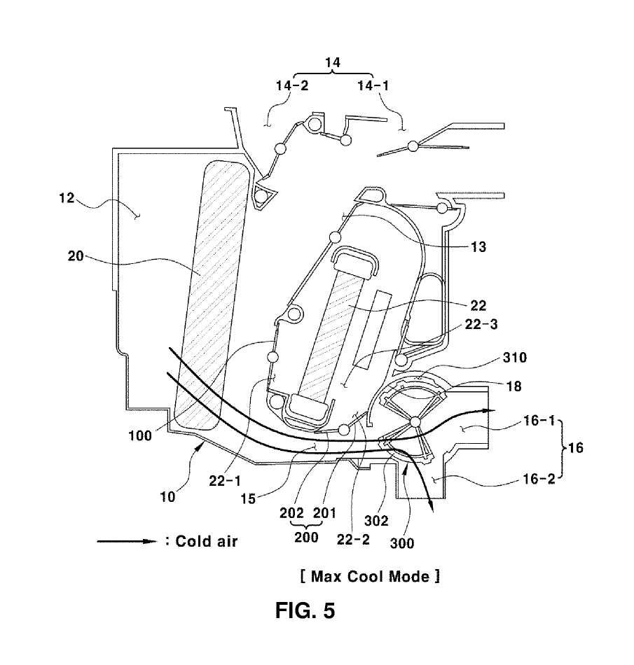

To this end, as can be seen in FIG. 6, the rear seat temperature door 100 is opened while the rear seat mixing door 200 is controlled to be rotated angularly to a position where the outlet 22-2 of the heater 22 is opened half and at the same time the rear seat air passage 15 is opened half.

Therefore, the air introduced through the air inlet 12 passes through the rear seat temperature door 100 and is heated by the heater 22, and then it is discharged toward the area of rear seats via the outlet 22-2. At the same time, the air introduced through the air inlet 12 is cooled in the evaporator 20 and then discharged toward the area of rear seats via the rear seat air passage 15.

In this way, the warm air heated by the heater 22 and the cold air cooled by the evaporator 20 can be mixed with each other and then discharged toward the area of rear seats while its temperature is regulated.

Similarly, the rear seat mode door 300 is rotated angularly in response to user's selection operation and hence the console outlet 16-1 or the floor outlet for rear seats 16-2 is opened or both the console outlet 16-1 and the rear floor outlet 16-2 is opened, so that the mixed air is discharged toward the desired area of rear seats.

As described above, a minimum number (i.e., three or less) of doors for regulating the air, such as a rear seat temperature door 100, a rear seat mixing door 200 and a rear seat mode door 300, can be mounted in the HVAC module for air conditioning of a vehicle to smoothly adjust a discharge direction and temperature of the air directed toward rear seats of the vehicle.

Particularly, it is possible to control mixing and temperature of the air discharged toward rear seats by means of only one mixing door 200 installed at a position where the outlet 22-2 of the heater 22 joins the rear seat air passage 15.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A rear seat air regulating device of a heating, ventilating and air conditioning (HVAC) module, the air regulating device comprising:
a housing having an air inlet formed at one side thereof, a front seat air passage and a front seat air outlet formed at an upper portion of the housing, and a rear seat air passage and a rear seat air outlet formed at a lower portion of the housing;
an evaporator disposed inside of the housing at a position inside the air inlet;
a heater disposed inside of the housing and spaced apart from a rear side of the evaporator;
a rear seat temperature door mounted at an inlet of the heater and being angularly rotatable to block or allow air flowing to the heater;
a rear seat mixing door mounted at a location where an outlet of the heater joins the rear seat air passage, the rear seat mixing door being angularly rotatable so that the rear seat mixing door can perform opening and closing of the outlet of the heater and opening and closing of the rear seat air passage simultaneously; and
a rear seat mode door mounted at the rear seat air outlet and being angularly rotatable to guide air to a console outlet or a rear floor.

2. The air regulating device of claim 1, further comprising a partition wall located between an installation space for the heater and an installation space for the rear seat mode door such that the outlet of the heater faces the rear seat air passage.

3. The air regulating device of claim 1, wherein the rear seat temperature door is made in a structure in which a first wing and a second wing are integrally formed on both sides of a first coupling sleeve for a rotary shaft.

4. The air regulating device of claim 3, wherein the first wing and the second wing maintain an angle of 180° with respect to each other.

5. The air regulating device of claim 1, the rear seat mixing door is made in a structure in which a first door for opening and closing the outlet of the heater and a second door for opening and closing the rear seat air passage are formed integrally with each other.

6. The air regulating device of claim 5, wherein the first door and the second door maintain an angle between 90° and 180° with respect to each other.

7. The air regulating device of claim 6, wherein second coupling sleeves for a rotary shaft are integrally formed on one surface of a boundary portion between the first door and the second door.

8. The air regulating device of claim 7, wherein a reinforcing rib for integrally connecting the first door and the second door is further formed on another surface of the first door and the second door.

9. The air regulating device of claim 1, wherein the rear seat mode door comprises symmetrical fan-shaped side plates integrally formed with third coupling sleeves for a rotary shaft and an arcuate opening/closing plate formed integrally between the symmetrical fan-shaped side plates.

10. The air regulating device of claim 1, wherein the air regulating device is configured to be operated in a Max Hot mode in which warm air passing through the heater is discharged to the rear seat air outlet, wherein the rear seat temperature door is controlled to be opened and the rear seat mixing door is controlled to be in a position where the outlet of the heater is opened and at the same time the rear seat air passage is closed in the Max Hot mode.

11. The air regulating device of claim 1, wherein the air regulating device is configured to be operated in a Max Cool mode in which cold air passed through the evaporator is discharged to the rear seat air outlet via the rear seat air passage, wherein the rear seat temperature door is controlled to be closed and the rear seat mixing door is controlled to be in a position where the outlet of the heater is closed and at the same time the rear seat air passage is opened in the Max Cool mode.

12. The air regulating device of claim 1, wherein the air regulating device is configured to be operated in a Mixing mode in which warm air passing through the heater and cold air passing through the evaporator are mixed with each other and then discharged to the rear seat air outlet, wherein the rear seat temperature door is controlled to be opened and the rear seat mixing door is controlled to be in a position where the outlet of the heater is opened halfway and at the same time the rear seat air passage is opened halfway in the Mixing mode.

13. A method of operating a heating, ventilating and air conditioning (HVAC) module having a rear seat air regulating device,
wherein the air regulating device comprises:
a housing having an air inlet formed at one side thereof, a front seat air passage and a front seat air outlet formed at an upper portion of the housing, and a rear seat air passage and a rear seat air outlet formed at a lower portion of the housing;
an evaporator disposed inside of the housing at a position inside the air inlet;
a heater disposed inside of the housing and spaced apart from a rear side of the evaporator;
a rear seat temperature door mounted at an inlet of the heater and being angularly rotatable to block or allow air flowing to the heater;
a rear seat mixing door mounted at a location where an outlet of the heater joins the rear seat air passage, the rear seat mixing door being angularly rotatable so that the rear seat mixing door can perform opening and closing of the outlet of the heater and opening and closing of the rear seat air passage simultaneously; and
a rear seat mode door mounted at the rear seat air outlet and being angularly rotatable to guide air to a console outlet or a rear floor; and
wherein the method comprises:
passing air into the air inlet;
affecting a temperature of the air using the heater or the evaporator; and
passing the air from the heater or the evaporator to a rear seat.

14. The method of claim 13, wherein passing the air from the heater or the evaporator comprises passing the air through the heater to the rear seat air outlet, wherein the rear seat temperature door opened and the rear seat mixing door is in a position where the outlet of the heater is opened and at the same time the rear seat air passage is closed.

15. The method of claim 13, wherein passing the air from the heater or the evaporator comprises passing the air through the evaporator to the rear seat air outlet via the rear seat air passage, wherein the rear seat temperature door is closed and the rear seat mixing door is in a position where the outlet of the heater is closed and at the same time the rear seat air passage is opened.

16. The method of claim 13, wherein passing the air from the heater or the evaporator comprises passing air through the heater and through the evaporator, mixing the air from the heater with the air from the evaporator, and discharging the mixed air to the rear seat air outlet.

17. The method of claim 16, wherein the rear seat temperature door is opened and the rear seat mixing door is in a position where the outlet of the heater is opened halfway and at the same time the rear seat air passage is opened halfway.
